(19) United States
(12) Patent Application Publication
(10) Pub. No.: US 2016/0363697 A1
(43) Pub. Date: Dec. 15, 2016

(54) Method for Manufacturing a Scanning Lens

(71) Applicant: Brother Kogyo Kabushiki Kaisha, Nagoya-shi (JP)

(72) Inventors: Hitoshi Fujino, Tajimi-shi (JP); Yoshifumi Nakamura, Ama-shi (JP); Hirotaka Hirabayashi, Nagoya-shi (JP)

(21) Appl. No.: 15/086,798

(22) Filed: Mar. 31, 2016

(30) Foreign Application Priority Data
Jun. 10, 2015 (JP) 2015-117175

(51) Int. Cl. G02B 1/04; G02B 13/00; B29C 45/72; G02B 26/12

(52) U.S. Cl. CPC G02B 1/041; G02B 26/125; G02B 13/0005; B29C 45/7207; B29K 2023/38

(57) ABSTRACT

A method for manufacturing a scanning lens elongate in a main scanning direction is disclosed. The method includes a first step of forming a lens by injecting a molten plastic material into a mold, and a second step of annealing the lens formed in the first step under conditions to modify optical properties of the lens such that: for each position to be scanned along the main scanning direction, |R×Δφ×Ws|≦19.248λ−2020.7 where R is a maximum of retardation by birefringence [nm], Δφ is a variation in optic axis orientation per unit length in a sub scanning direction [deg/mm], Ws is a beam width in the sub scanning direction at an incident surface of the scanning lens [mm], and λ is a wavelength of a beam [nm].

### CROSS-REFERENCE TO RELATED APPLICATION(S)

This application claims priority from Japanese Patent Application No. 2015-117175 filed on Jun. 10, 2015, the disclosure of which is incorporated herein by reference in its entirety.

### TECHNICAL FIELD

Methods disclosed herein relate to manufacture of a scanning lens made of plastic.

### BACKGROUND ART

Scanning lenses molded of plastic are known in the art. Among materials available for such a scanning lens, rigid materials of high flexural strength which resists fracture during the molding process are preferred, but many of such rigid materials have high photoelastic coefficients. Therefore, a scanning lens as molded of such a material would exhibit a high level of birefringence (due to residual stress resulting from the molding process) which should be detrimental to its imaging characteristics.

### SUMMARY

In order to reduce the detrimental effect of birefringence, the molded scanning lens may be annealed. However, annealing, if excessively applied, would disadvantageously cause thermal deformation of a lens surface. On the other hand, insufficient annealing would leave some residual stress unremoved which would disadvantageously fail to sufficiently reduce birefringence, thus deteriorating the imaging characteristics.

In this respect, it would be desirable to provide a method for manufacturing a scanning lens which exhibits improved properties in terms of birefringence to thereby enhance imaging characteristics.

In one aspect, a method for manufacturing a scanning lens elongate in a main scanning direction is disclosed herein. The method comprises a first step of forming a lens by injecting a molten plastic material into a mold, and a second step of annealing the lens formed in the first step under conditions to modify optical properties of the lens such that:

for each position to be scanned along the main scanning direction,

|R×Δφ×Ws|≦19.248λ−2020.7 (1)

where R is a maximum of retardation by birefringence [nm], Δφ is a variation in optic axis orientation per unit length in a sub scanning direction [deg/mm], Ws is a beam width in the sub scanning direction at an incident surface of the lens [mm], and λ is a wavelength of a beam [nm].

### BRIEF DESCRIPTION OF THE DRAWINGS

The above and other aspects, their advantages and further features will become more apparent in detail illustrative, non-limiting description with reference to the accompanying drawings, in which:

FIG. 1 is a sectional view of a light-scanning optical system including a scanning lens taken along a main scanning plane;

FIG. 2A is a graph showing a relationship between positions fixed in the main scanning direction and varying along the sub scanning direction and retardation;

FIG. 2B is a graph showing maximum values R of retardation as varying with positions along the main scanning direction, before and after annealing process;

FIG. 3A is a graph showing a relationship between positions fixed in the main scanning direction and varying along the sub scanning direction and optic axis orientation φ;

FIG. 3B is a graph showing Δφ as varying with positions along the main scanning direction, before and after annealing process;

FIG. 4 is a graph showing a relationship between positions along the main scanning direction and beam width Ws in the sub scanning direction;

FIG. 5 is a graph showing |R×Δφ×Ws| as varying with positions along the main scanning direction, before and after annealing process;

FIG. 6 is a graph showing temperatures for annealing process; and

FIG. 7 is a graph showing a relationship between |R×Δφ×Ws|max as a maximum of values of |R×Δφ×Ws| obtained in positions along the main scanning direction and image surface shift in the sub scanning direction.

### DESCRIPTION OF EMBODIMENTS

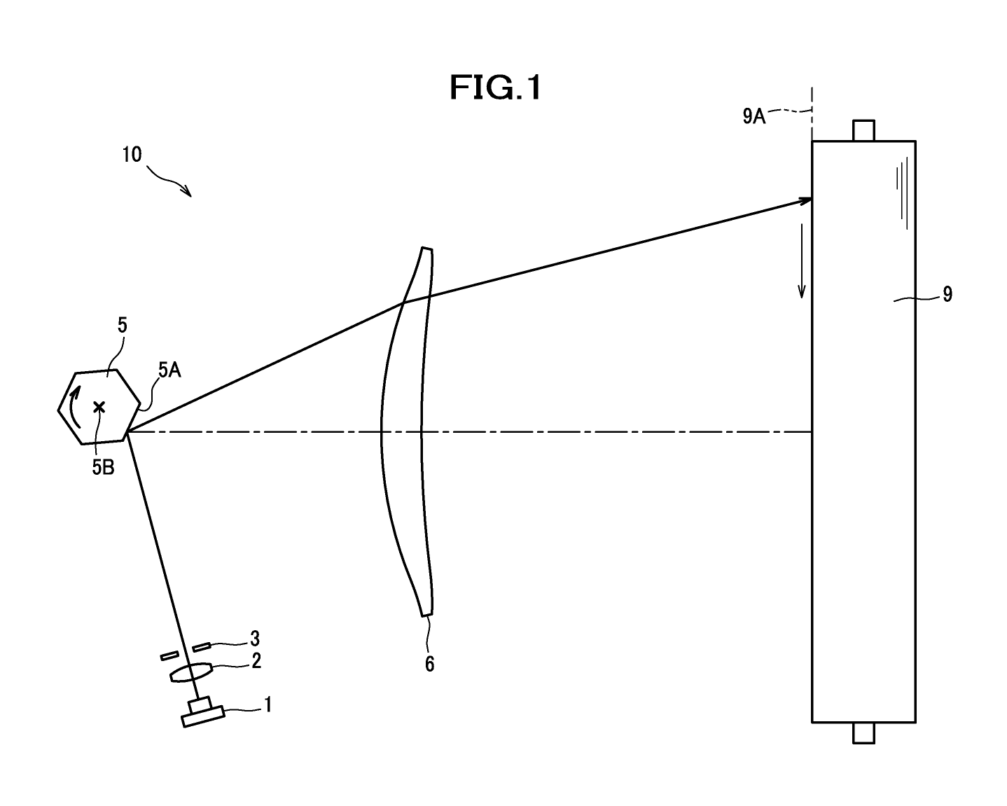

A detailed description will be given of an illustrative, non-limiting embodiment with reference made to the drawings where appropriate. In the following description, a general setup of a light-scanning optical system with a scanning lens as an illustrative example will be described briefly with reference to FIG. 1 at the outset, and then a method for manufacturing a scanning lens will be described in detail.

As shown in FIG. 1, a scanning optical system 10 includes a semiconductor laser 1, a coupling lens 2, an aperture stop 3, a polygon minor 5, and a scanning lens 6. With these elements in the scanning optical system 10, a light beam (laser beam) emitted from the semiconductor laser 1 is focused on an image surface 9A of a photoconductor drum 9 in the form of a dot-like image with which the image surface 9A is scanned. These elements of the semiconductor laser 1, the coupling lens 2, the aperture stop 3, the polygon mirror 5, and the scanning lens 6 are arranged and fixed on a housing made of plastic (not shown).

The coupling lens 2 is provided between the semiconductor laser 1 and the polygon mirror 5 and configured to convert the light beam emitted from the semiconductor laser 1 into a light beam converging slightly in a main scanning direction and focused near a reflecting surface 5A of the polygon mirror 5 in a sub scanning direction. Herein, the main scanning direction is a direction in which the beam is deflected by the polygon minor 5, that is, the lateral (right-left) direction in FIG. 1. The sub scanning direction is a direction orthogonal to the main scanning direction and to the direction of travel of the beam, that is, the direction orthogonal to the drawing sheet of FIG. 1.

The aperture stop 3 is a member having an aperture defining sizes, in the main scanning direction and in the sub scanning direction, of the light beam coming from the coupling lens 2 (beam widths or diameters).

The polygon mirror 5 has a plurality of reflecting surfaces (specular surfaces) 5A disposed equidistantly from an axis 5B of rotation of the polygon mirror 5; the polygon mirror 5 shown in FIG. 1 has six reflecting surfaces 5A by way of example. The polygon mirror 5 spins at a constant rotational speed about the axis of rotation 5B and causes the light beam having passed through the aperture stop 3 to be deflected in the main scanning direction.

The scanning lens 6 is arranged to allow a laser beam reflected and thus deflected by the polygon minor 5 to pass therethrough. This scanning lens 6 is configured to converge the laser beam in the main scanning direction and the sub scanning direction into a spot-like image to be focused on the image surface 9A to be scanned. The scanning lens 6 is also configured to correct an optical face tangle error of each reflecting surface 5A of the polygon minor 5. The scanning lens 6 has f-theta characteristics such that the laser beam deflected at a constant angular velocity by the polygon minor 5 is converted into a laser beam that scans the image surface 9A at a constant linear velocity.

The scanning lens 6 is made of plastic material and has an elongate shape (elongate in the main scanning direction). The plastic material for the scanning lens 6 preferably has a glass transition temperature between or equal to 135° C. and 145° C. Such a relatively high glass transition temperature of the plastic material used for molding the scanning lens 6 serves to enhance the flexural strength of the scanning lens 6.

The plastic material for the scanning lens 6 may preferably have a photoelastic coefficient (absolute value) equal to or greater than 1.5×10⁻¹⁴ [Pa⁻¹]. The photoelastic coefficient (absolute value) of the plastic material for the scanning lens 6 may preferably be equal to or smaller than 1.0×10⁻¹² [Pa⁻¹]. For example, the plastic material may be cyclic polyolefin.

A method for manufacturing a scanning lens 6 will be described hereafter.

First, the scanning lens 6 is formed by injecting a molten plastic material into a mold (first step).

Next, in order to reduce the residual stress in the scanning lens 6 for improved properties in terms of birefringence (i.e., in favor of reduced birefringence), the scanning lens 6 formed in the first step is annealed (second step). In this step, if the annealing is insufficient, the birefringence would still be at such a non-negligible level that the imaging characteristics at the image surface 9A with a laser beam passing through the scanning lens 6 could become deteriorated as compared with the case in which no birefringence is observed. Contrariwise, if the annealing is subjected excessively, the shape of the lens surface of the scanning lens 6 would be distorted, which could also result in deterioration of its imaging characteristics. With this in view, the second step of annealing the scanning lens 6 is executed under conditions specified (optimized) to modify the optical properties of the scanning lens 6 to those which satisfy the following conditions (1) and (2):

for each position to be scanned along the main scanning direction,

|R×Δφ×Ws|≦19.248λ−2020.7 (1)

where R is a maximum of retardation by birefringence [nm], Δφ is a variation in optic axis orientation per unit length in the sub scanning direction [deg/mm], Ws is a beam width in the sub scanning direction at an incident surface of the scanning lens [mm], and λ is a wavelength of a beam [nm], and

5000≦R×Δφ×Ws|max (2)

where |R×Δφ×Ws|max is a maximum of values of |R×Δφ×Ws| obtained in positions to be scanned along the main scanning direction within a main scanning range.

The inequality (1) represents the condition under which a laser beam (with any of wavelengths of 850, 788, 650 and 515 [nm]) passing through the scanning lens 6 and striking the image surface 9A forms a beam spot having a diameter not increased more than 10% as compared with the case with a lens in which no birefringence is observed. Therefore, the annealing step executed under this condition (1), even if it is subjected to a scanning lens 6 formed of a material with a high photoelastic coefficient, will result in improved imaging characteristics of the scanning lens 6.

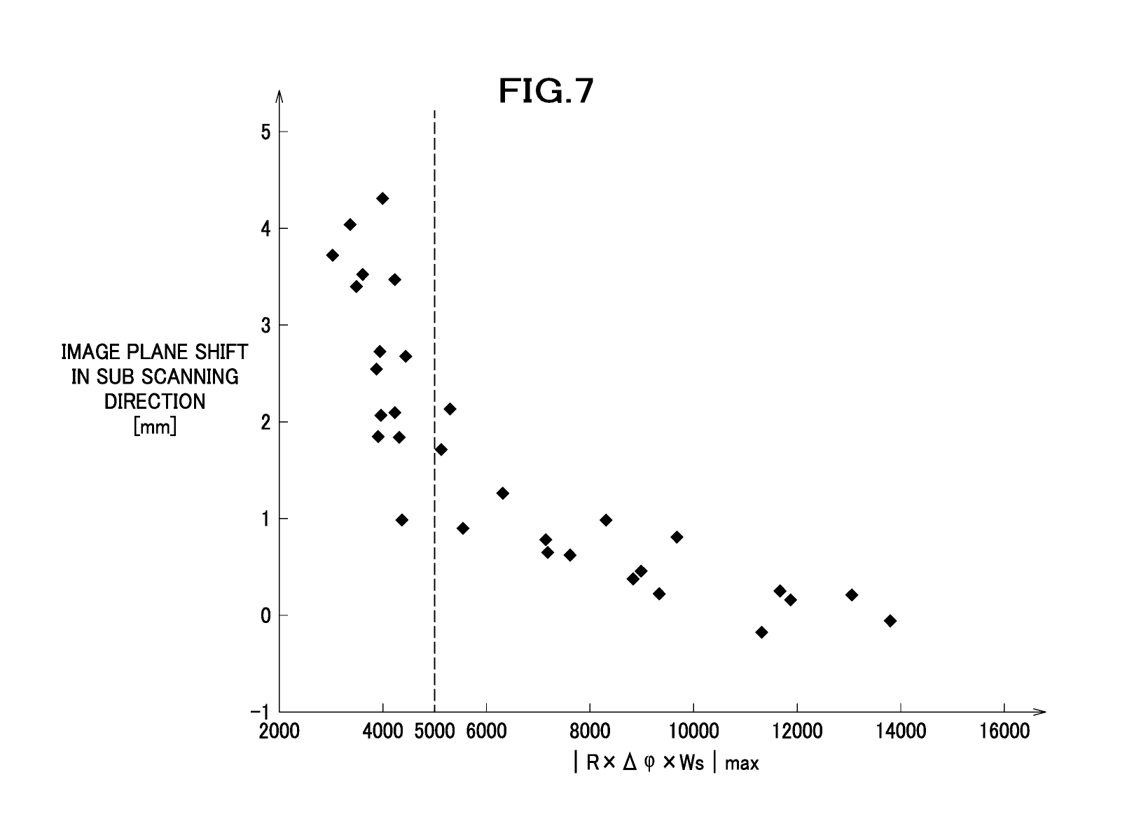

The inequality (2) represents the lower limit of |R×Δφ×Ws|max with which distortion in the shape of the lens surface of the scanning lens 6 as would be caused by annealing process falls within a permissible range. As annealing process proceeds, |R×Δφ×Ws|max decreases. However, as shown in FIG. 7, if |R×Δφ×Ws|max is smaller than 5000, a non-negligible shift of an image point (i.e., image plane shift) in the sub scanning direction is observed. Therefore, the annealing step executed under this condition (2) serves to significantly reduce the deterioration of the shape of the surface of the scanning lens 6.

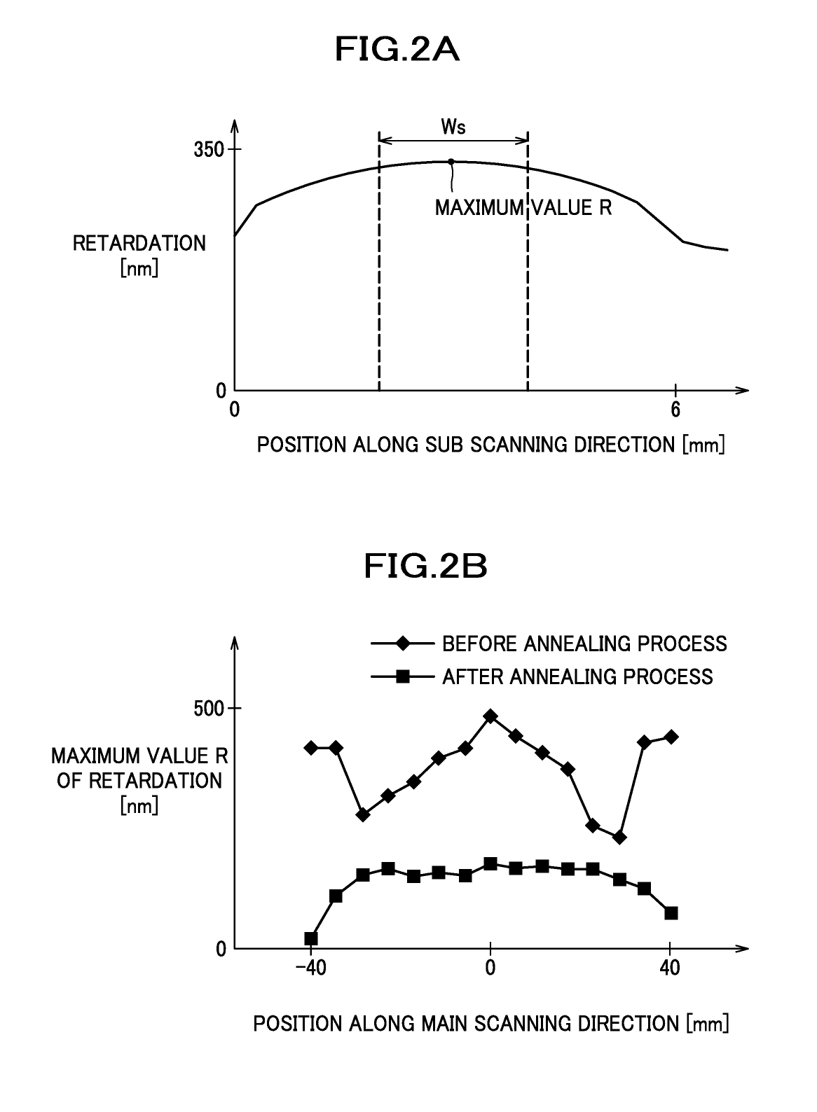

Variables employed in the inequalities (1) and (2) will be described hereafter with reference to FIGS. 2 to 6, in which the graphs are shown by way of example, and it is to be understood that the values of R, Δφ and Ws vary depending on the differences in plastic materials for the scanning lens 6, molding methods for the scanning lens 6, and annealing processes for the scanning lens 6.

FIG. 2A represents retardation caused by birefringence in a fixed position in the main scanning direction. Values of retardation vary in positions along the sub scanning direction. The maximum R of retardation caused by birefringence in each position scanned is a maximum value of retardation as determined within a width (in the sub scanning direction) of a region through which a laser beam passes, that is, the beam width Ws indicated by broken lines in FIG. 2A.

As shown in FIG. 2B, the maximum R of retardation by birefringence in each position scanned along the main scanning direction becomes smaller by the annealing process subjected to the scanning lens 6, and the differences among the positions along the main scanning direction become smaller.

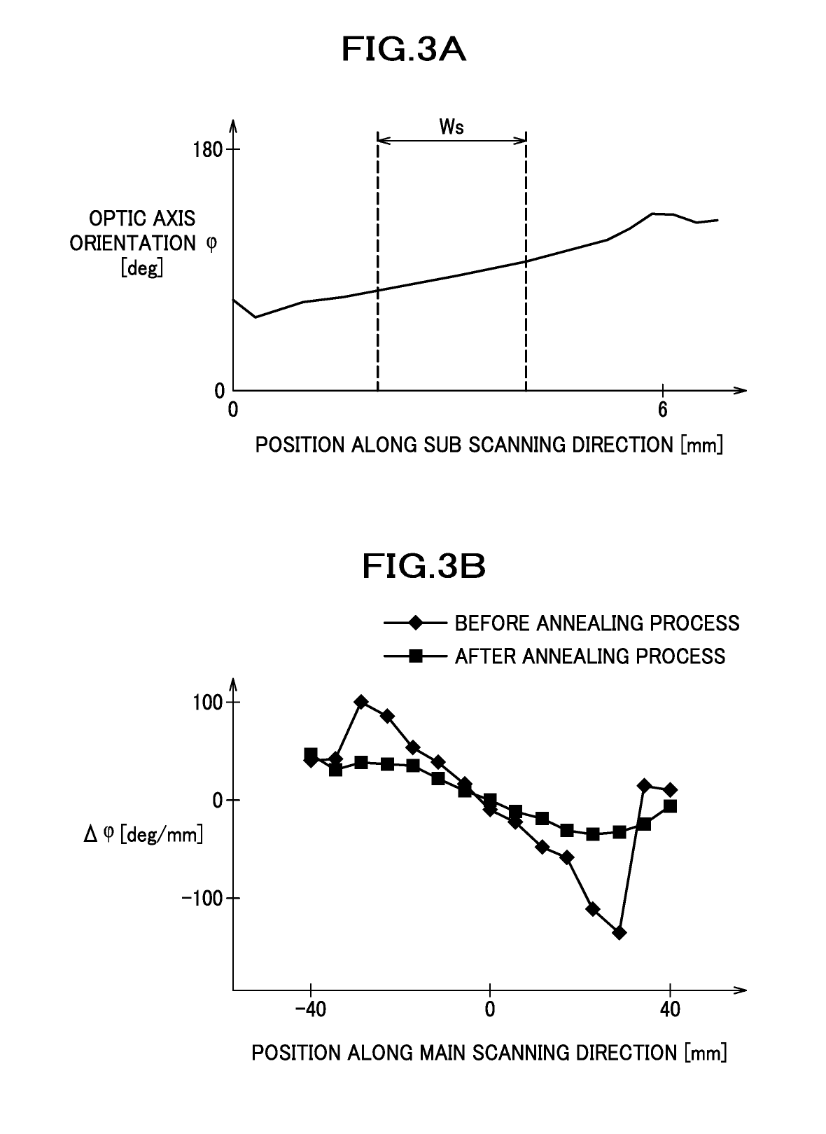

As shown in FIG. 3A, the optic axis orientation y in the birefringent phenomenon gradually shifts (rotates) in one direction with positions fixed in the main scanning direction and shifting in one direction along the sub scanning direction. Relationship between the positions along the sub scanning direction and the optic axis orientation y is approximated to a cubic spline y=ax³+bx²+cx+d within a width (in the sub scanning direction) of a region through which a laser beam passes, that is, the beam width Ws indicated by broken lines in FIG. 3A, and its coefficient c is assumed to be the variation Δφ in optic axis orientation y per unit length in the sub scanning direction for each position to be scanned along the main scanning direction

As shown in FIG. 3B, as a result of annealing subjected to the scanning lens 6, the variation Δφ in optic axis orientation y per unit length in the sub scanning direction for each position to be scanned along the main scanning direction is reduced when compared among the positions to be scanned along the main scanning direction.

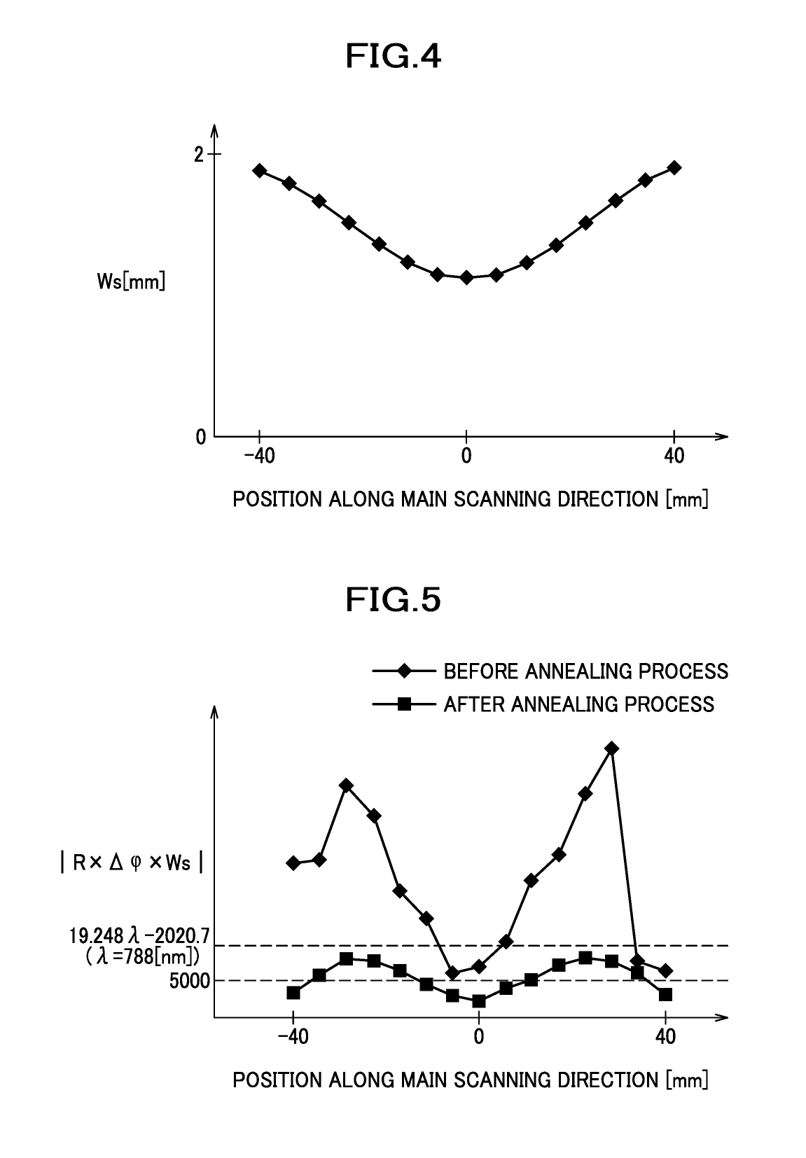

The beam width Ws in the sub scanning direction at an incident surface of the scanning lens 6 varies with the positions to be scanned along the main scanning direction. For instance, the beam width Ws in the sub scanning direction at the incident surface of the scanning lens 6 increases toward outside in the main scanning direction, as shown in FIG. 4.

As described above, the value of |R×Δφ×Ws| for each position to be scanned along the main scanning direction becomes smaller after annealing than before annealing and the variation thereof as compared among the positions to be scanned along the main scanning direction becomes smaller after annealing than before annealing.

In this specific example, the annealing step is executed to modify the optical properties of the lens such that, after annealing, the value of |R×Δφ×Ws| for each position to be scanned along the main scanning direction satisfies |R×Δφ×Ws|≦19.2482λ−2020.7 and 5000≦|R×Δφ×Ws|max.

Next, the method of annealing in the second step will now be described in detail.

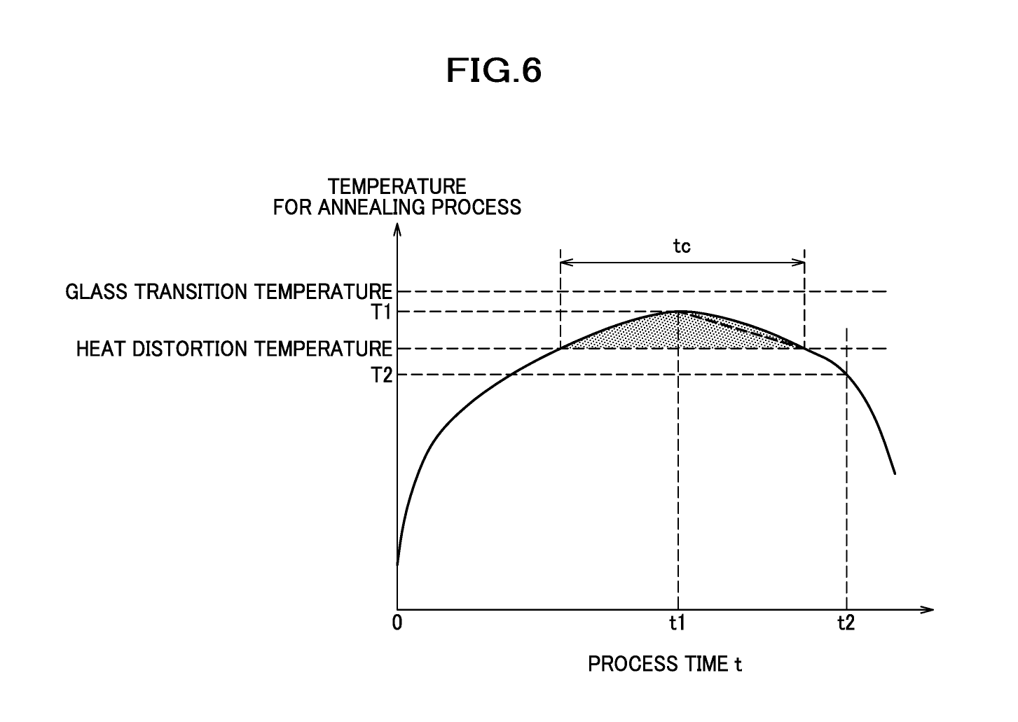

In the second step, as shown in FIG. 6, the annealing process is executed by keeping, for a predetermined period of time tc, a temperature of the scanning lens 6 within a predetermined range that is higher than a heat distortion temperature of the plastic material and lower than a glass transition temperature of the plastic material. To be more specific, in this annealing process, a scanning lens 6 formed in the first step is put in an annealing furnace (t=0), and the temperature for the annealing process (i.e., the temperature inside the annealing furnace; hereinafter referred to as “furnace temperature”) is raised from room temperature toward a target maximum temperature T1. When the furnace temperature reaches the target maximum temperature T1 (t=t1), the furnace temperature is lowered with a predetermined gradient (i.e., at a predetermined cooling rate). Herein, the cooling rate is an amount of drop in temperature per unit time. When the furnace temperature lowers to a takeout temperature T2 that is lower than the heat distortion temperature (t=t2), the scanning lens 6 is taken out of the annealing furnace.

The predetermined period of time tc is determined with a temperature condition fixed within the predetermined range, such that the optical properties of the scanning lens 6 achieved after the annealing process satisfy both of the conditions (1) and (2). To be more specific, the predetermined period of time tc is determined such that the area of a shaded region in FIG. 6, that is, the integral of the remainder obtained by subtracting the heat distortion temperature from the furnace temperature, has a predetermined (fixed) value.

To give an example, the target maximum temperature T1 may be a temperature lower than the glass transition temperature by 1.5 to 4.5° C., for example, by 3° C., the takeout temperature T2 may be a temperature lower than the heat distortion temperature by a degree not less than 7° C., and the cooling rate may be 2.0° C./min. or less.

It is to be understood that various modifications and changes may be made to the specific structure and process steps as described above by way of example.

In the above description, the scanning lens 6 is made of cyclic polyolefin. The plastic material for the scanning lens 6 may be cyclic polyolefin polymer or cyclic polyolefin copolymer.

Furthermore, the plastic material for the scanning lens 6 is not limited thereto; for example, the plastic material for the scanning lens 6 may be other plastic material such as polycarbonate.

What is claimed is:

1. A method for manufacturing a scanning lens elongate in a main scanning direction, the method comprising:
a first step of forming a lens by injecting a molten plastic material into a mold; and
a second step of annealing the lens formed in the first step under conditions to modify optical properties of the lens such that:
for each position to be scanned along the main scanning direction,

|R×Δφ×Ws|≦19.248λ−2020.7 (1)
where R is a maximum of retardation by birefringence [nm], Δφ is a variation in optic axis orientation per unit length in a sub scanning direction [deg/mm], Ws is a beam width in the sub scanning direction at an incident surface of the scanning lens [mm], and λ is a wavelength of a beam [nm].

2. The method according to claim 1, wherein the conditions under which the second step is executed are configured to achieve optical properties of the scanning lens such that:
5000≦|R×Δφ×Ws|max (2)
where |R×Δφ×Ws|max is a maximum of values of |R×Δφ×Ws| obtained in positions to be scanned along the main scanning direction within a main scanning range.

3. The method according to claim 2, wherein the conditions under which the second step is executed include keeping, for a predetermined period of time, a temperature for annealing within a predetermined range that is higher than a heat distortion temperature of the plastic material and lower than a glass transition temperature of the plastic material, wherein the predetermined period of time is determined with a temperature condition fixed within the predetermined range, such that the optical properties of the scanning lens achieved after annealing in the second step satisfy both of the conditions (1) and (2).

4. The method according to claim 1, wherein an absolute value of a photoelastic coefficient of the plastic material is equal to or greater than 1.5×10⁻¹⁴ [Pa⁻¹].

5. The method according to claim 1, wherein an absolute value of a photoelastic coefficient of the plastic material is equal to or smaller than 1.0×10⁻¹² [Pa⁻¹].

6. The method according to claim 1, wherein a glass transition temperature of the plastic material is between or equal to 135° C. and 145° C.

7. The method according to claim 1, wherein the plastic material includes cyclic polyolefin.
